(19) United States
(12) Patent Application Publication
(10) Pub. No.: US 2006/0081175 A1
(43) Pub. Date: Apr. 20, 2006

(54) Coating system for protective layer forming material

(76) Inventor: Bansei Nagase, Saitama (JP)

Correspondence Address: FISH & RICHARDSON P.C., P.O. BOX 1022, MINNEAPOLIS, MN, 55440-1022, US

(21) Appl. No.: 10/545,340

(22) PCT Filed: Feb. 20, 2004
(86) PCT No.: PCT/JP04/01984

§ 371 Date: Aug. 11, 2005

(30) Foreign Application Priority Data
Feb. 21, 2003 (JP) 2003-043833
Apr. 17, 2003 (JP) 2003-112806
Dec. 2, 2003 (JP) 2003-403254

(51) Int. Cl. B05C 1/00; B05C 1/16

(52) U.S. Cl. 118/220; 118/313; 118/264; 118/258

(57) ABSTRACT

A coating system (10a) has a first coating station (ST1), a second coating station (ST2), and a third coating station (ST3), which are successively arranged downstream with respect to the conveying direction of vehicles (14). Each of the coating stations has a plurality of robots (16). In the first coating station (ST1), mainly an entire upper surface of the vehicle (14) is supplied and roughly coated with a protective layer forming material. In the second coating station (ST2), the roughly applied protective layer forming material is spread. In the third coating station (ST3), the protective layer forming material is finished.

### TECHNICAL FIELD

The present invention relates to a coating system for applying a protective layer forming material to an outer surface which mainly comprises a painted area of a workpiece which has been painted. Specifically, the present invention relates to a coating system for applying a liquid protective layer forming material that functions as a peelable protective layer after being dried.

### BACKGROUND ART

After being manufactured, vehicles are often stored in an outdoor stockyard or transported by a trailer, a ship, or the like until they are handed over to users. Since the vehicles are exposed to dust, metal particles, salt, oil, acid, direct sunlight, etc. while they are in storage or transportation, the surface layer of a plurality of coating layers on the outer surface of the vehicles tends to become lower in quality. To prevent the surface layer from being deteriorated, there is known a process of forming a peelable protective layer on the painted area before the vehicle is shipped out (see, for example, Japanese Laid-Open Patent Publication No. 2001-89697). The peelable protective layer is formed by applying and drying a protective layer forming material (also called “strippable paint”) which is a liquid wrap material, and can protect the painted area. The protective layer forming material can easily be peeled off when it is to be removed, and is not peeled off of its own when in normal storage.

For applying the protective layer forming material to be dried into the peelable protective layer, the protective layer forming material is applied to a roller, and the roller is rolled to coat the surface layer with the protective layer forming material.

In order to automate the coating process and uniformize the coating quality, there has been proposed a process of pouring a protective layer forming material onto a body and applying air to spread the protective layer forming material (see, for example, Japanese Laid-Open Patent Publication No. 8-173882). According to the proposed process, many steps of a process of applying the protective layer forming material are automated to lower the burden on the worker and improve the takt time.

Recent vehicle bodies are becoming more complex in shape, and some of them have convexities and concavities and complex and delicate curved surfaces. On surfaces to be coated which have such convexities and concavities and complex and delicate curved surfaces, the protective layer forming material may not necessarily be spread uniformly by the process disclosed in Japanese Laid-Open Patent Publication No. 8-173882. According to the disclosed process, the protective layer forming material is scattered around on edge areas of roofs and engine hoods (vehicle end areas). Therefore, it is not preferable to perform the disclosed process on such areas. Furthermore, though it is necessary to apply the protective layer forming material to a greater thickness in areas where the coating quality is of particular importance, it is difficult to adjust the thickness of the coating material when the protective layer forming material is spread by an air nozzle.

One solution is to eject the protective layer forming material from a nozzle, for example. However, if the protective layer forming material is ejected across an increased spread width from the nozzle, then the protective layer forming material tends to be scattered in dots. If the spread width is reduced to prevent the protective layer forming material from being scattered in dots, then the vehicle cannot efficiently be coated with the protective layer forming material.

Consequently, after the protective layer forming material is spread by an air nozzle, several workers are required to coat small spots such as roof edges, convexities and concavities, etc. with the protective layer forming material and finish the coating, using a roller. The process of applying the protective layer forming material is thus performed partly manually, is burdensome on the workers, and results in different coating quality levels depending on how the workers are skilled.

In order to reduce the burden on the workers and uniformize the job quality levels, the roller that has heretofore been used by the workers may be operated by industrial robots. However, unplanned use of robots is liable to cause a reduction in production efficiency. Specifically, the conveyor line for vehicles may become longer and the coating process may not be finished within a prescribed takt time due to robot layout problems.

In view of the demands for coating process automation and coating quality uniformization, the present applicant has proposed a coating system and a coating method for a protective layer forming material as disclosed in Japanese Patent Application No. 2002-381880. According to Japanese Patent Application No. 2002-381880, the process of coating the outer surface of a vehicle with a protective layer forming material is automated by a roller operated by a robot for increasing the production efficiency, simplifying the job, and uniformizing the coating quality.

In factories for producing vehicles, it is customary to temporarily cover vehicle bodies with resin-made covers known as scratch covers to prevent the vehicle bodies from being damaged during the assembling process. A scratch cover is temporarily applied to a front lateral surface of a vehicle body, and removed before the vehicle is shipped out. It is necessary to prepare scratch covers having different shapes for different vehicle types, and also to prepare a large number of scratch covers depending on the number of vehicles to be produced day to day on the conveyor line.

### DISCLOSURE OF THE INVENTION

The present invention has been made in relation to the invention of Japanese Patent Application No. 2002-381880. It is an object of the present invention to provide a coating system for coating the outer surface of a workpiece to be coated with a protective layer forming material in a reduced number of process steps more appropriately uniformly and more efficiently.

According to the present invention, a coating system for a protective layer forming material includes a robot disposed closely to a conveying line for a vehicle and having an applicator on a tip end thereof, the robot being trainable for operation, two or three coating stations disposed along the conveying line, each of the coating stations having a predetermined number of the robots, and a supply mechanism for supplying the applicator with a liquid-phase protective layer forming material which will form a peelable protective film after being dried, wherein the coating stations include a first coating station for supplying the protective layer forming material to a surface of the vehicle through the applicators of the robots, and roughly applying the supplied protective layer forming material.

Since a given number of robots each having an applicator are positioned in each of the coating stations, the robots can appropriately be assigned to processes of supplying and applying the protective layer forming material in the coating stations. As a result, the surface of the vehicle can properly and uniformly be coated with the protective layer forming material. Since the coating system is flexibly compatible with the types, shapes, and numbers of produced vehicles, the vehicles can efficiently be produced.

The protective layer forming material may comprise an acrylic copolymer, which can protect a painted area of the vehicle more reliably and can easily be peeled off when to be removed.

The coating stations include second and third coating stations, and the robots in at least one of the second and third coating stations may apply the protective layer forming material while newly supplying the protective layer forming material through the applicators. Since the protective layer forming material is appropriately supplied in not only the first coating station, but also the second or the third coating station, it is possible to apply the protective layer forming material more properly and more uniformly.

If the applicator comprises a roller made of a material which is capable of absorbing and holding the protective layer forming material, then it can easily apply the protective layer forming material.

The first coating station may have a discharging and coating mechanism for discharging or dropping and spreading the protective layer forming material, in place of the robots. In the first coating station, the discharging and coating mechanism which is inexpensive is sufficiently capable of supplying and roughly coating the protective layer forming material. Therefore, it is not necessary to employ relatively expensive robots, and the coating system for a protective layer forming material can be manufactured less costly.

The coating stations may comprise the first coating station, a second coating station for spreading the protective layer forming material which has roughly been applied by the applicators and supplying the protective layer forming material, and a third coating station for finishing the protective layer forming material which has been spread by the applicators and supplying the protective layer forming material.

As described above, a given number of robots each having an applicator are employed, and the robots are appropriately disposed in each of the first, second, and third coating stations (i.e., three processes). Therefore, the robots can appropriately be assigned to processes of supplying and applying the protective layer forming material in the coating stations. As a result, the surface of the vehicle can properly and uniformly be coated with the protective layer forming material. Since the coating system is flexibly compatible with the types, shapes, and numbers of produced vehicles, the vehicles can efficiently be produced.

If the first coating station has two of the robots, the second coating station has three of the robots, and the third coating station has two of the robots, then the robots can appropriately be assigned to their jobs, and can easily be trained and controlled.

Alternatively, the coating stations may comprise the first coating station and a second coating station for spreading the protective layer forming material which has roughly been applied by the applicators and supplying the protective layer forming material.

With at least one robot being disposed on each of the left and right sides in each of the first and second coating stations, the coating process for coating each vehicle can be completed within a prescribed takt time in the two coating stations (i.e., two processes).

If the first coating station has three of the robots, and the second coating station has two of the robots, then the robots can appropriately be assigned to their jobs, and can easily be trained and controlled.

The coating system may further include ejecting mechanisms disposed in the first coating station for ejecting the protective layer forming material from ejectors of the robots, and applying the ejected protective layer forming material to the vehicle, and roller mechanisms disposed in at least one of second and third coating stations of the coating stations, for supplying the protective layer forming material to rollers of the robots and rotating the rollers on the vehicle to apply the protective layer forming material to the vehicle.

According to the present invention, there is also provided a coating system for a protective layer forming material, comprising a robot disposed closely to a conveying line for a vehicle and having an applicator on a tip end thereof, the robot being trainable for operation, a coating station disposed along the conveying line and having at least two of the robots on each of left and right sides of the conveying line, and a supply mechanism for supplying the applicator with a liquid-phase protective layer forming material which will form a peelable protective film after being dried, wherein the coating station supplies the protective layer forming material to a surface of the vehicle through the applicators of the robots, and roughly applies and finishes the supplied protective layer forming material.

With at least two robots being disposed on each of the left and right sides in one coating station, the coating process for coating each vehicle can be completed within a prescribed takt time in one process.

If the coating station includes five of the robots, then the robots are easily prevented from mutually interfering with each other, and the coating system is less subject to size limitations of the robots.

According to the present invention, there is further provided a coating system for coating a workpiece with a liquid-phase protective layer forming material which will form a peelable protective film after being dried in each of a first coating station and a second coating station, comprising ejecting mechanisms disposed in either one of the first coating station and the second coating station, for ejecting the protective layer forming material from ejectors of coating apparatus and applying the ejected protective layer forming material to an area of the workpiece, and roller mechanisms disposed in the other of the first coating station and the second coating station, for supplying the protective layer forming material to rollers of the coating apparatus and rotating the rollers on the workpiece to apply the protective layer forming material to an area of the workpiece other than the area thereof which has been coated by the ejecting mechanisms.

A wide area of the workpiece such as a vehicle is coated with the protective layer forming material by the ejecting mechanisms which are capable of applying the protective layer forming material to a wide range within a short period of time, and the remaining area of the workpiece is coated with the protective layer forming material by the roller coating mechanisms which are capable of accurately applying the protective layer forming material.

When the workpiece is coated by the ejecting mechanisms, coating failures and coating irregularities may tend to occur due to the protective layer forming material being scattered as spots at ends of the workpiece. According to the present invention, however, the roller coating mechanisms apply the protective layer forming material to the ends of the workpiece. This process is effective to prevent the protective layer forming material from being applied as spots to the ends of the workpiece. Therefore, the protective layer forming material can be applied efficiently without irregularities to the ends of the workpiece. As coating failures and coating irregularities can be suppressed, a uniform peelable protective layer is formed.

If the coating apparatus comprise robots, and the workpiece comprises a vehicle, then they are movable along complex shapes of the vehicle. The roller coating mechanisms should preferably coat ends of the vehicle with the protective layer forming material. The ejecting mechanisms coat a central area of the vehicle with the protective layer forming material.

Preferably, the ejecting mechanisms are disposed in the first coating station, and the roller mechanisms are disposed in the second coating station. Stated otherwise, after the ejecting mechanisms apply the protective layer forming material to a wide area of the workpiece, the remaining area of the workpiece is preferably finished with the protective layer forming material by the roller coating mechanisms. Thus, coating failures and coating irregularities can be suppressed more effectively.

In any case, the rollers should preferably be made of a material which is capable of absorbing and holding the protective layer forming material. The rollers are thus capable of absorbing an excessively applied amount of protective layer forming material. Since any excessive protective layer forming material is prevented from remaining on the workpiece, coating irregularities can be suppressed more effectively.

Preferably, the ejecting mechanisms apply the protective layer forming material in the first coating station, and the roller coating mechanisms apply the protective layer forming material in the second coating station. The protective layer forming material ejected from the ejecting mechanisms is applied to a wider area than the protective layer forming material applied by the roller coating mechanisms. Therefore, the protective layer forming material can be applied without coating failures and coating irregularities, by coating a wide area of the workpiece with the protective layer forming material by the ejecting mechanisms and thereafter finishing the protective layer forming material with the roller coating mechanisms at remaining ends of the workpiece.

The ejecting mechanisms should preferably be capable of ejecting the protective layer forming material free of air, i.e., should preferably be of the airless type. The ejecting mechanisms of the airless type can produce coated patterns of the protective layer forming material applied at a given coating width and in a given amount, with much more reproducibility than general ejecting mechanisms which eject the protective layer forming material containing air. Stated otherwise, desired coated patterns can easily be obtained.

Preferably, the coating system further includes a water pipe for supplying water to the ejectors, wherein the ejectors are cleaned by water supplied thereto. With this arrangement, a protective layer forming material supply line and ejectors can be cleaned simply by switching between the lines. Stated otherwise, the coating system can easily be serviced for maintenance.

### BRIEF DESCRIPTION OF THE DRAWINGS

FIG. 1 is a perspective view of a second coating station incorporated in a coating system for a protective layer forming material according to a first embodiment;

FIG. 2 is a front elevational view of the second coating station;

FIG. 3 is a perspective view of a robot in the second coating station;

FIG. 4 is a circuit diagram of a composite hydraulic and pneumatic circuit;

FIG. 5 is a plan view of the coating system for a protective layer forming material according to the first embodiment;

FIG. 6 is a plan view of a coating system for a protective layer forming material according to a second embodiment;

FIG. 7 is a side elevational view of a protective precoating apparatus incorporated in the coating system for a protective layer forming material according to the second embodiment;

FIG. 8 is a front elevational view of the protective precoating apparatus;

FIG. 9 is a plan view of a coating system for a protective layer forming material according to a third embodiment;

FIG. 10 is a plan view of a coating system for a protective layer forming material according to a fourth embodiment;

FIG. 11 is a plan view of a coating system for a protective layer forming material according to a fifth embodiment;

FIG. 12 is a perspective view of a first coating station of the coating system for a protective layer forming material shown in FIG. 11;

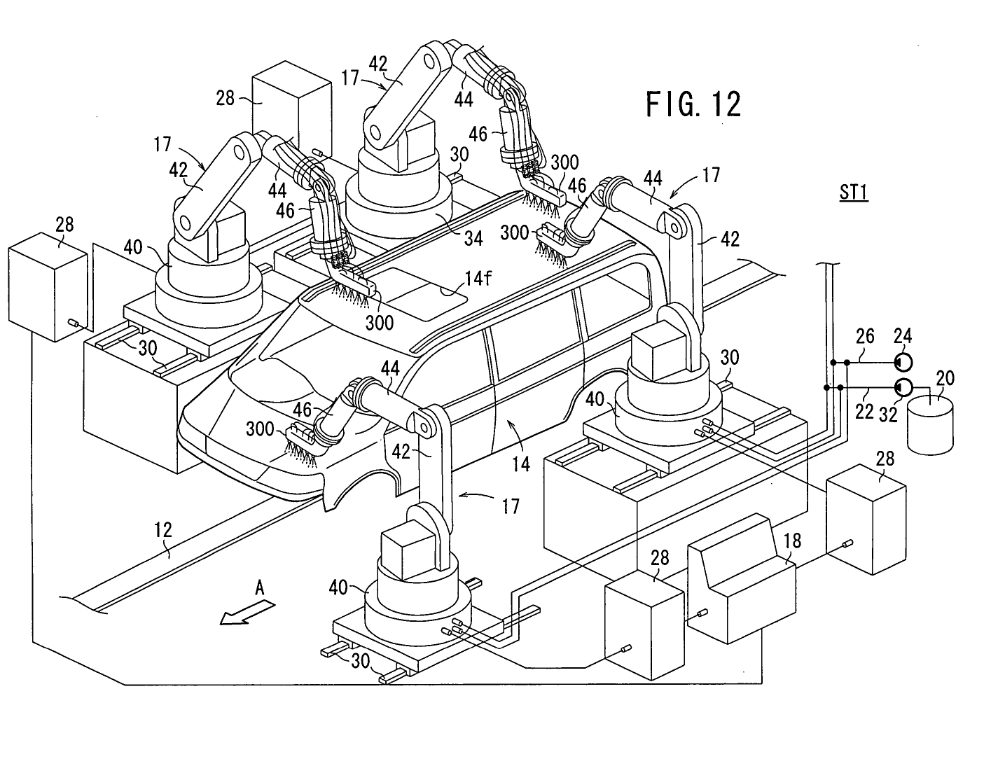

FIG. 13 is a perspective view of each of robots disposed in the first coating station shown in FIG. 12; and

FIG. 14 is a circuit diagram of a composite hydraulic and pneumatic circuit applied to the robot shown in FIG. 13.

### BEST MODE FOR CARRYING OUT THE INVENTION

Preferred embodiments of a coating system for a protective layer forming material according to the present invention will be described below with reference to the accompanying drawings.

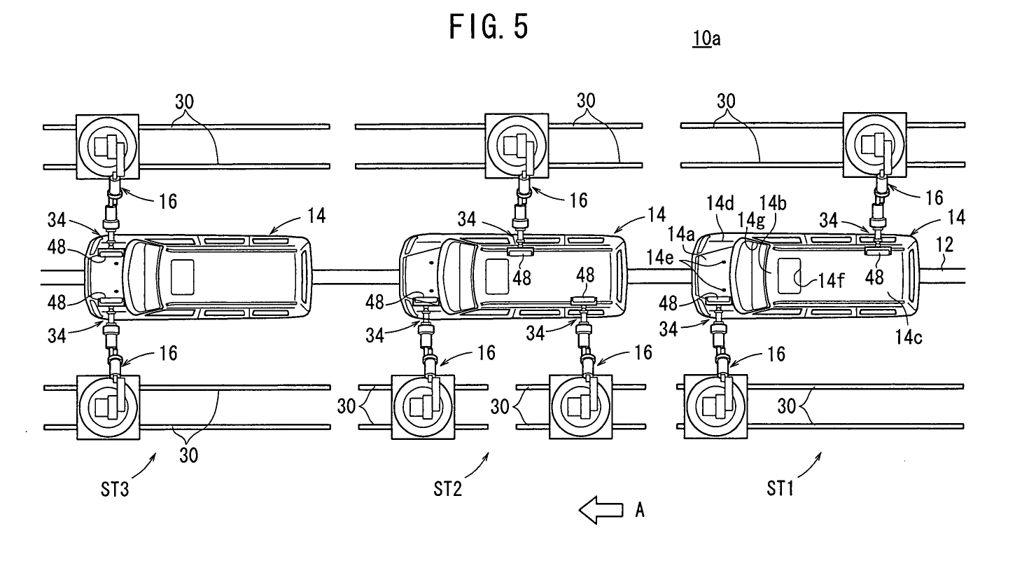

First, a first coating station ST1, a second coating station ST2, and a third coating station ST3, which are successively arranged in a conveying direction, incorporated in a coating system 10a for a protective layer forming material according to a first embodiment will be described below. The second coating station ST2 will be described below as representing the coating stations of the coating system 10a (see FIG. 5).

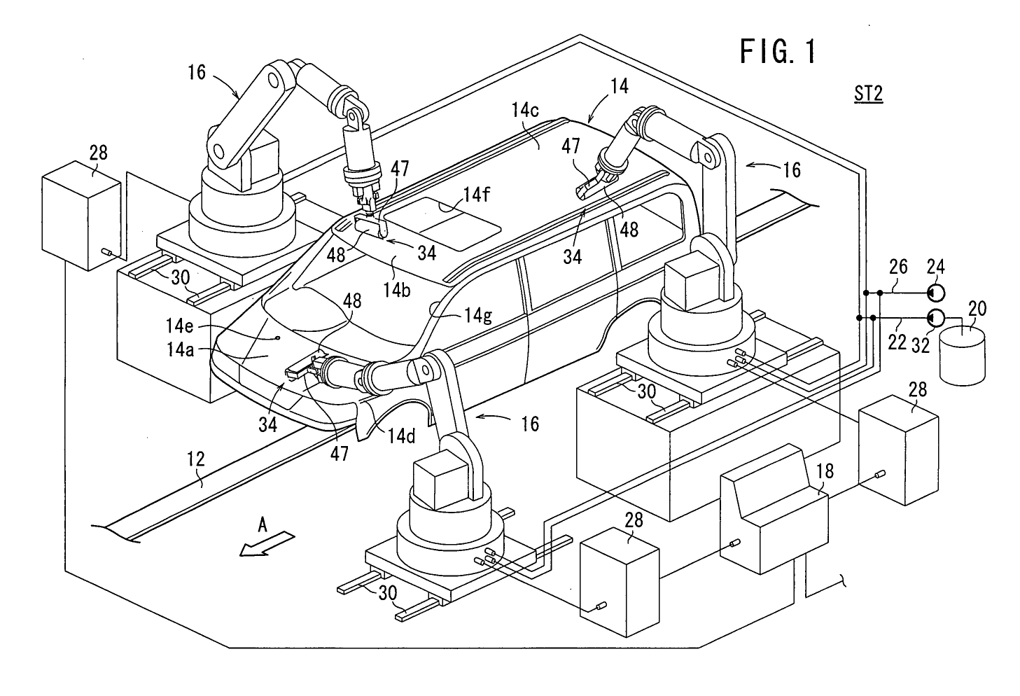

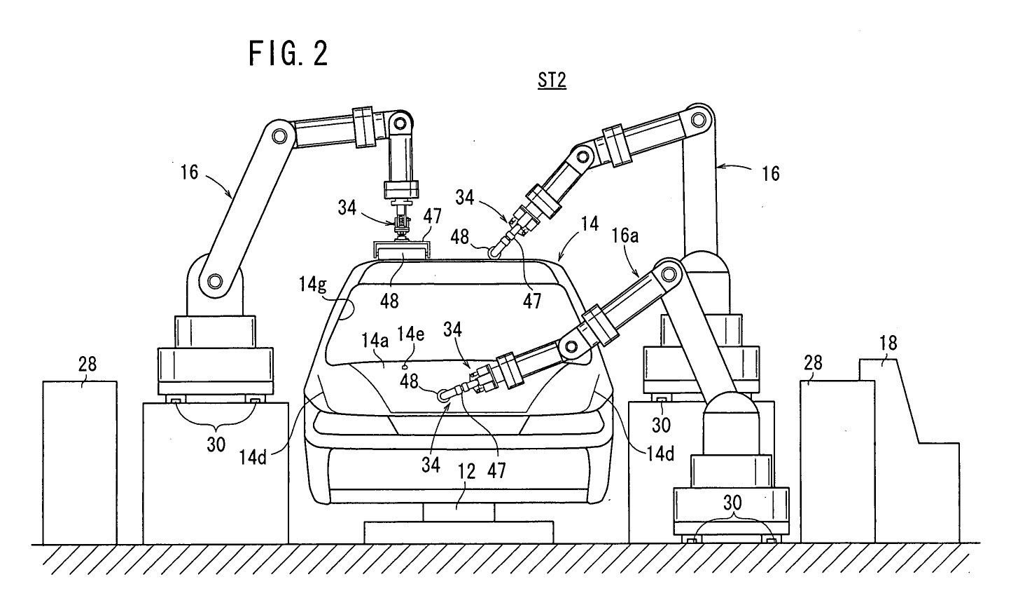

As shown in FIGS. 1 and 2, the second coating station ST2 is disposed on a conveying line 12 for vehicles 14, and coats a painted vehicle 14 with a protective layer forming material. The second coating station ST2 comprises three industrial articulated robots (coating apparatus) 16, a control console 18 for controlling the coating system 10a in its entirety, a tank 20 storing the protective layer forming material therein, a coating material pipe 22 extending from the tank 20 to the robots 16, and a water pipe 26 for supplying water from a water source 24 to the robots 16. The robots 16 are controlled by respective robot controllers 28 that are connected to the control console 18. Though three robots 16 are illustrated, the number of robots 16 may be set to any value.

Two robots 16 are disposed on the left side of the conveying line 12 with respect to the conveying direction (the direction indicated by the arrow A) of the vehicle (coated workpiece) 14, and one robot 16 is disposed on the right side of the conveying line 12. The robots 16 are disposed in front, middle, and rear positions, respectively, along the conveying direction of the vehicle 14. The robots 16 are movable on slide rails 30 parallel to the conveying line 12.

A pump 32 is connected to the coating material pipe 22 for drawing the protective layer forming material from the tank 20 and supplying the protective layer forming material to the robots 16. The protective layer forming material is controlled to have a suitable temperature by a heater and a thermometer, not shown. The robots 16 have on their arm ends roller mechanisms (applicators) 34 which are supplied with the protective layer forming material through the coating material pipe 22.

The protective layer forming material is chiefly made of an acrylic copolymer, and preferably includes two acrylic copolymers having different glass transition temperatures. Specifically, the protective layer forming material may be a protective layer forming material disclosed in Japanese Laid-Open Patent Publication No. 2001-89697 referred to above. The protective layer forming material has its viscosity adjustable depending on its ratio to water mixed therewith and temperature changes. When the protective layer forming material is dried, it is held in close contact with the vehicle 14 for chemically and physically protecting the painted area of the vehicle 14 from dust, metal particles, salt, oil, acid, direct sunlight, etc. The protective layer forming material can easily be peeled off if it is to be removed when the vehicle 14 is delivered to the user.

The viscosity of the protective layer forming material is adjusted such that it will not flow down even if it is applied to curved or bent areas of the vehicle 14. By setting the viscosity to a large value, the protective layer forming material can be applied to vertical surfaces of the vehicle 14. Therefore, painted areas of the vertical surfaces of the vehicle 14 can be protected, and the vehicle 14 is prevented from being damaged during its assembling process. Accordingly, scratch covers for those painted areas can be omitted.

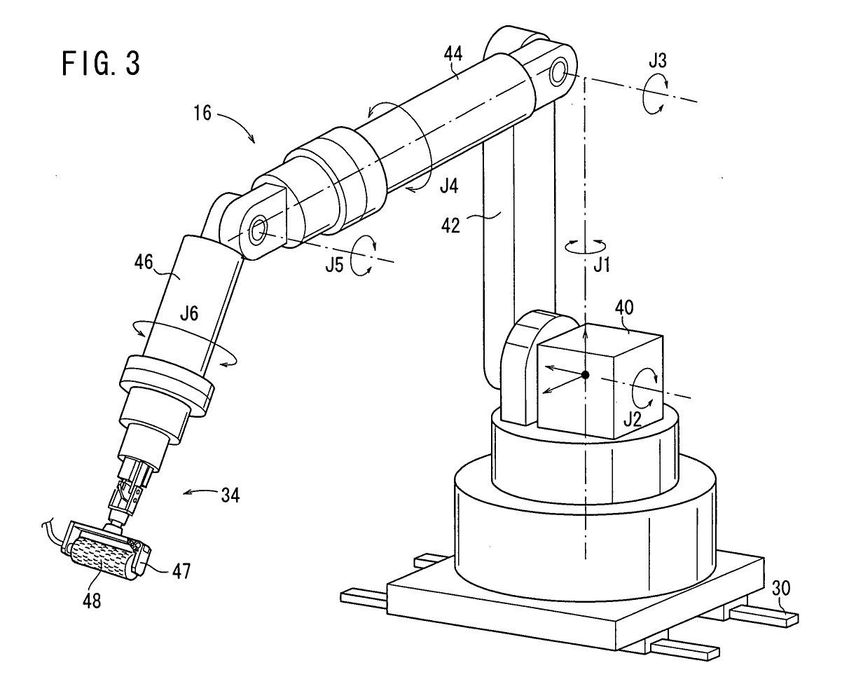

As shown in FIG. 3, the robot 16 has a base 40, and a first arm 42, a second arm 44, and a third arm 46 which are successively extend from the base 40. The roller mechanism 34 is mounted on the tip end of the third arm 46. The roller mechanism 34 is detachable from the third arm 46, and operates as a so-called end effector. The first arm 42 is horizontally and vertically rotatable with respect to the base 40 about axes J1, J2. The second arm 44 is connected to the first arm 42 for rotation about an axis J3. The second arm 44 can be twisted about an axis J4. The third arm 46 is connected to the second arm 44 for rotation about an axis J5. The third arm 46 can be twisted about an axis J6.

The roller mechanism 34 connected to the tip end of the robot 16 can be moved to any desired position near the vehicle 14 and can be oriented in any direction by the movement of the 6-axis robot 16. Stated otherwise, the roller mechanism 34 is movable with six degrees of freedom. The robot 16 may have actuators for making expansion and contraction, parallel link motion, etc., in addition to the rotation. The roller mechanism 34 has a cylindrical roller 48 supported by a holder 47. The roller 48 absorbs and holds the supplied protective layer forming material, and is brought into close contact with the surface of the vehicle 14 to apply the protective layer forming material thereto. The roller 48 is preferably made of sponge, bristles, etc. The roller 48 is removable from the holder 47 for replacement, cleaning, and maintenance.

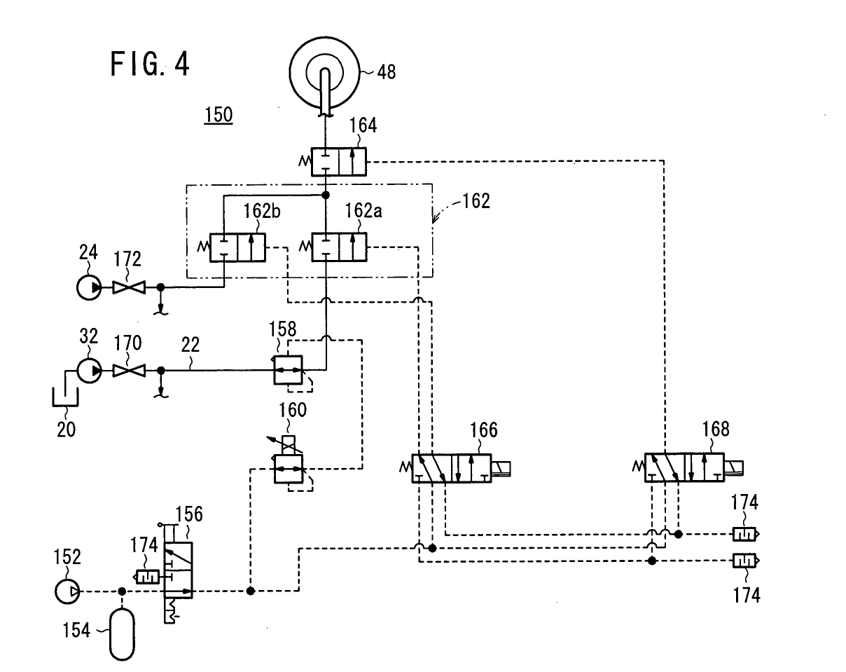

As shown in FIG. 4, the roller 48 is supplied with the protective layer forming material by a composite hydraulic and pneumatic circuit (supply mechanism) 150. The composite hydraulic and pneumatic circuit 150 has a compressor 152, an air tank 154 connected to the outlet port of the compressor 152, a manually operated pneumatic charge valve 156 for selectively supplying and blocking a pneumatic pressure, a regulator control valve 160 for reducing a secondary pressure with an electric signal supplied from the control console 18, and a regulator 158 which is pilot-controlled by the secondary pressure of the regulator control valve 160 for reducing the pressure in the coating material pipe 22.

The composite circuit 150 also has an MCV (Material Control Valve: supply switching valve) 162 to which the secondary pipe of the regulator control valve 160 and the water pipe 26 are connected, and a trigger valve 164 disposed between the secondary side of the MCV 162 and the roller 48. The MCV 162 has switching valves 162a, 162b for selectively bringing the coating material pipe 22 and the water pipe 26 into and out of communication with each other. The switching valves 162a, 162b have respective secondary sides communicating with each other. Broken lines in FIG. 4 represent pneumatic pipes.

The MCV 162, the trigger valve 164, and the regulator control valve 160 are not limited to pneumatic pilot-operated valves, but may be valves that are actuatable by electric solenoids or the like.

The composite circuit 150 further includes an MCV switching solenoid-operated valve 166 for selectively supplying the pneumatic pressure from the pneumatic charge valve 156 to pilot-operate the switching valves 162a, 162b, and a trigger switching solenoid-operated valve 168 for pilot-operating the trigger valve 164. When supplied with an electric signal from the control console 18, the MCV switching solenoid-operated valve 166 opens either one of the switching valves 162a, 162b and closes the other of the switching valves 162a, 162b, selectively supplying water and the protective layer forming material to the trigger valve 164. In response to an electric signal from the control console 18, the trigger switching solenoid-operated valve 168 selectively opens and closes the trigger valve 164 to supply water or the protective layer forming material to the trigger valve 164.

Manual shut-off valves 170, 172 are connected respectively to the coating material pipe 22 and the water pipe 26. The shut-off valves 170, 172 are normally open. Silencers 174 are connected to respective air outlet ports of the composite circuit 150 for reducing discharged air noise. The compressor 152, the pump 32, and the water source 24 are combined with respective relief valves (not shown) for preventing an undue pressure buildup.

The bottom side of a pneumatic cylinder 52 is supplied with depressurized air through a solenoid-pilot-operated regulator 176. The regulator 176 is electrically operated by the control console 18 or manually operated by a predetermined dial or the like to change the secondary pressure arbitrarily when the protective layer forming material is applied. The regulator 176 has a secondary side connected to the bottom side of the pneumatic cylinder 52. Air in the rod-side chamber of the pneumatic cylinder 52 can be discharged through a silencer 174.

The compressor 152, the air tank 154, the water source 24, and the pump 32 of the composite circuit 150 are shared by the robots 16. Other devices are individually associated with the robots 16.

The coating system 10a for a protective layer forming material according to the first embodiment will be described below.

As shown in FIG. 5, the coating system 10a for a protective layer forming material comprises the first coating station ST1, the second coating station ST2, and the third coating station ST3, which are successively arranged downstream with respect to the conveying direction of vehicles 14.

In the first coating station ST1, robots 16 are disposed one on each side of the conveying direction of vehicles 14. Each robot 16 is disposed on slide rails 30 laid over a length that is substantially the same as the length of the vehicles 14.

In the second coating station ST2, two robots 16 are disposed on the left side of the conveying direction of vehicles 14, and one robot 16 is disposed on the right side of the conveying direction of vehicles 14. The two robots 16 that are disposed on the left side of the conveying direction are disposed on individual slide rails 30 corresponding to those robots 16. The robot 16 that is disposed on the right side of the conveying direction is disposed on slide rails 30 laid over a length that is substantially the same as the length of the vehicles 14.

The two robots 16 that are disposed on the left side of the conveying direction may be disposed on the same slide rails 30. In this case, electric interlock controls and mechanical collision prevention functions may be provided for preventing the robots 16 from interfering with each other.

In the third coating station ST3, robots 16 are disposed forwardly one on each side of the conveying direction of vehicles 14. Each robot 16 is disposed on slide rails 30 laid over a length that is substantially the same as the length of the vehicles 14.

Operation and advantages of the coating system 10a for a protective layer forming material, which is constructed as described above, will be described below.

The robots 16 in the first coating station ST1, the second coating station ST2, and the third coating station ST3 are trained to perform coating operation. The robots 16 are assigned to an engine hood 14a, a central roof area 14b, a rear roof area 14c, and front fenders 14d, etc., and are trained to apply the protective layer forming material. The areas to which the robots 16 are assigned may overlap each other.

The robots 16 may be trained by actually operating the robots 16 and holding the rollers 48 in contact with desired areas of vehicles 14 as visually confirmed by the operator. Alternatively, the robots 16 may be trained by a so-called off-line teaching process in which the robots 16 are trained by a three-dimensional CAD process using a solid model or the like. In any case, the robots 16 are trained to finish the process of applying the protective layer forming material within a takt time that is set for each vehicle 14 on the conveying line 12.

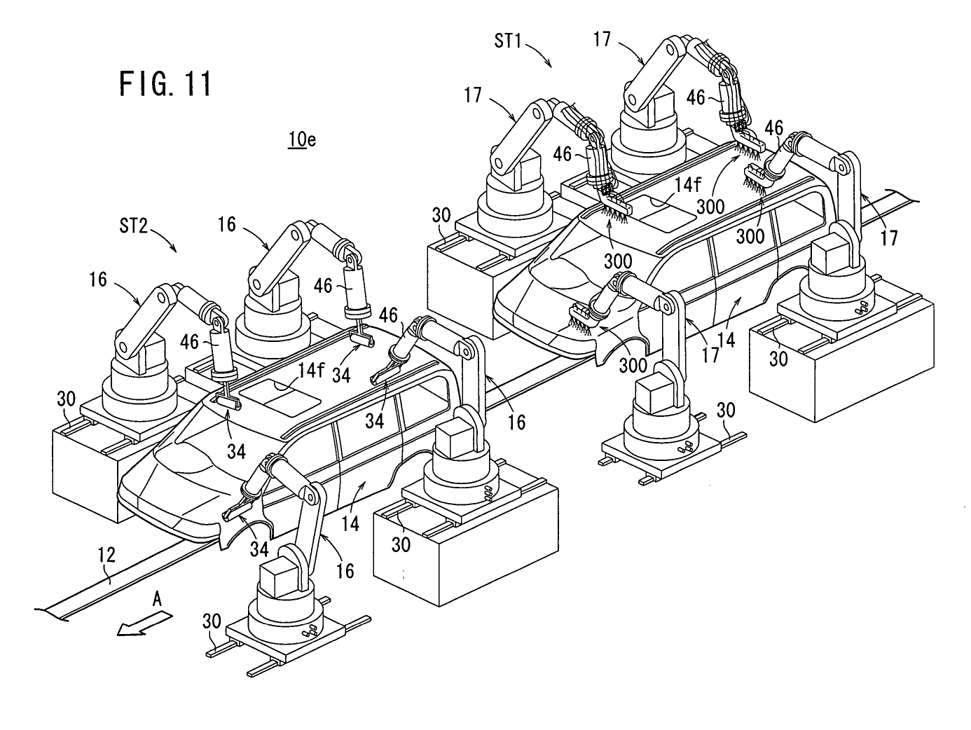

The conveying line 12 may be compatible with a plurality of vehicle types or one vehicle type wherein different vehicles have different minor shapes including sunroof openings 14f (see FIG. 11), bulges, rear spoilers, etc. In order for the robots 16 to be able to handle these different vehicle types and different minor shapes, the robots 16 may be trained to coat these different vehicle types and different minor shapes. The robots 16 are trained not to coat washer nozzle holes 14e, sunroof openings 14f, openings 14g for front windshields, etc. If the vehicles 14 are sedans, then the robots 16 that are positioned behind the vehicles 14 are assigned to trunk lids of the vehicles 14.

The control console 18 receives a signal representative of the vehicle type and minor shapes of vehicles, selects teaching data based on the received signal, and operates the robots 16.

Since the roller mechanism 34 is movable with six degrees of freedom by the mechanism of the robot 16, the roller mechanism 34 is compatible with vehicles 14 of complex shapes.

Based on the teaching data by which the robots 16 have been trained, the control console 18 controls the coating operation of the robots 16 in the first coating station ST1, the second coating station ST2, and the third coating station ST3, thereby coating the vehicles 14 introduced into the coating system 10a with the protective layer forming material. The vehicles 14 to be coated may be vehicles that have been painted, and may be unfinished vehicles with no parts mounted thereon.

At this time, the control console 18 controls the MCV 162 through the MCV switching solenoid-operated valve 166 to open the coating material pipe 22 and close the water pipe 26, and also controls the trigger switching solenoid-operated valve 168 to open the trigger valve 164. The protective layer forming material as it is kept under appropriate pressure and at appropriate temperature is now supplied to the roller 48 of the roller mechanism 34, whereupon a suitable amount of protective layer forming material seeps out from the surface of the roller 48.

As shown in FIG. 5, in the first coating station ST1, each of the robots 16 operates to supply and roughly coat a surface of the vehicle 14, mainly an entire upper surface thereof, with the protective layer forming material.

Then, in the second coating station ST2, each of the robots 16 operates to spread the protective layer forming material that has been roughly applied to the surface of the vehicle 14.

At this time, the protective layer forming material may be newly supplied to the surface of the vehicle 14. Therefore, even if the protective layer forming material that has been supplied in the first coating station ST1 is insufficient, the shortage may be made up for in the second coating station ST2. The central roof area 14b and the rear roof area 14c of the vehicle 14 can easily be coated by the robots 16 because the central roof area 14b and the rear roof area 14c include many flat surfaces. Consequently, the coating of the central roof area 14b and the rear roof area 14c may be completed in the second coating station ST2.

Then, in the third coating station ST3, the protective layer forming material which has been spread in the second coating station ST2 is finished. Alternatively, in the third coating station ST3, areas which have not sufficiently been coated in the first and second coating stations ST1, ST2 may selectively be coated.

Those areas may be areas ranging from the engine hood 14a to the front fenders 14d. Because the areas ranging from the engine hood 14a to the front fenders 14d include many curved surfaces of the vehicle 14 and are often inclined forwardly of the vehicle 14, they are relatively difficult to be coated by the robots 16.

In the coating system 10a for a protective layer forming material, the robots 16 are positioned in the first, second, and third coating stations ST1, ST2, ST3 as described above (see FIG. 5). However, the robots 16 are not limited to be positioned as illustrated, but may be appropriately positioned depending on the type of the vehicle 14 (e.g., a sedan, a coupe, a station wagon, etc.), the shape of the vehicle 14 (e.g. the extent of surface convexities and concavities and curved surfaces, the positions and sizes of holes, whether there is a rear spoiler or not, etc.), and changes in the number of produced vehicles 14, etc.

Depending on such changes, the robots 16 may be trained for coating operation in the first coating station ST1, the second coating station ST2, and the third coating station ST3. The control console 18 can thus receive a signal representative of vehicle information indicating the type, shape, and number of vehicles to be coated with the protective layer forming material, from the conveying line 12 of the coating system 10a, select teaching data based on the signal, and control the robots 16 in the first coating station ST1, the second coating station ST2, and the third coating station ST3.

With the coating system 10a for a protective layer forming material according to the first embodiment, as described above, since the robots 16 for coating the vehicle 14 are appropriately positioned in the first, second, and third coating stations ST1, ST2, ST3, the robots 16 can appropriately be assigned to processes of supplying and applying the protective layer forming material in the first, second, and third coating stations ST1, ST2, ST3. As a result, the surface of the vehicle 14 can properly and uniformly be coated with the protective layer forming material.

Actually, a plurality of robots 16 disposed in each of the coating stations ST1, ST2, ST3 are capable of completing the coating operation in the three coating stations ST1, ST2, ST3. If the coating operation is performed in the three coating stations ST1, ST2, ST3 of the coating system 10a, then two robots 16 may be provided in the first coating station ST1, three robots 16 may be provided in the second coating station ST2, and two robots 16 may be provided in the third coating station ST3, so that they can properly be assigned to their jobs (see FIG. 5). As the robots 16 are properly assigned to their jobs, the possibility of mutual interference thereof is small, and the robots 16 can easily be trained and controlled.

Even if the protective layer forming material that has been supplied in the first coating station ST1 is not sufficient, the shortage can be compensated for by newly supplying and coating the surface of the vehicle 14 with the protective layer forming material in the second coating station ST2 or the third coating station ST3. As a consequence, the surface of the vehicle 14 can be coated with the protective layer forming material more properly and more uniformly. Since the coating system is flexibly compatible with the types, shapes, and numbers of produced vehicles 14, the vehicles 14 can efficiently be produced.

Inasmuch as the protective layer forming material is applied while it is being supplied, the protective layer forming material continuously flows without staying stagnant, and is hence prevented from being solidified in the coating material pipe 22, for example.

The protective layer forming material thus applied is dried, naturally or with an air flow, into a peelable protective layer which protects the painted area of the vehicle 14.

Some bumpers of vehicles 14 are colored and do not need to be painted, but areas other than painted areas such as those bumpers may be coated with the protective layer forming material.

A coating system 10b for a protective layer forming material according to a second embodiment will be described below. Those parts of the coating system 10b for a protective layer forming material according to the second embodiment which are identical to those of the coating system 10a for a protective layer forming material according to the first embodiment are denoted by identical reference characters, and will not be described in detail below.

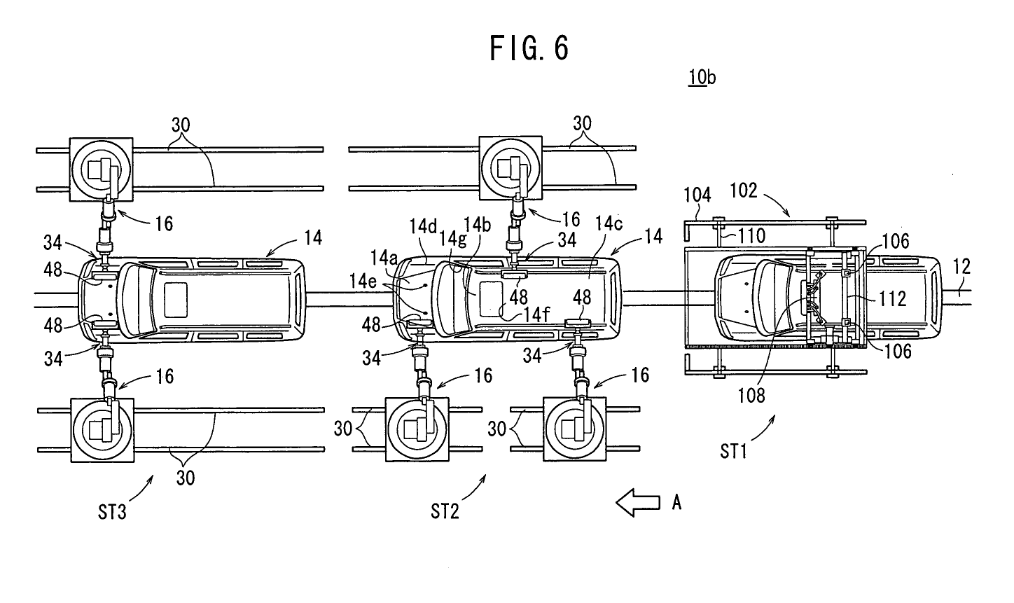

As shown in FIG. 6, the coating system 10b employs a protective precoating apparatus (discharging and coating mechanism) 102 instead of the robots 16 in the first coating station ST1 of the coating system 10a. The protective precoating apparatus 102 is an apparatus disclosed in Japanese Laid-Open Patent Publication No. 8-173882 referred to above.

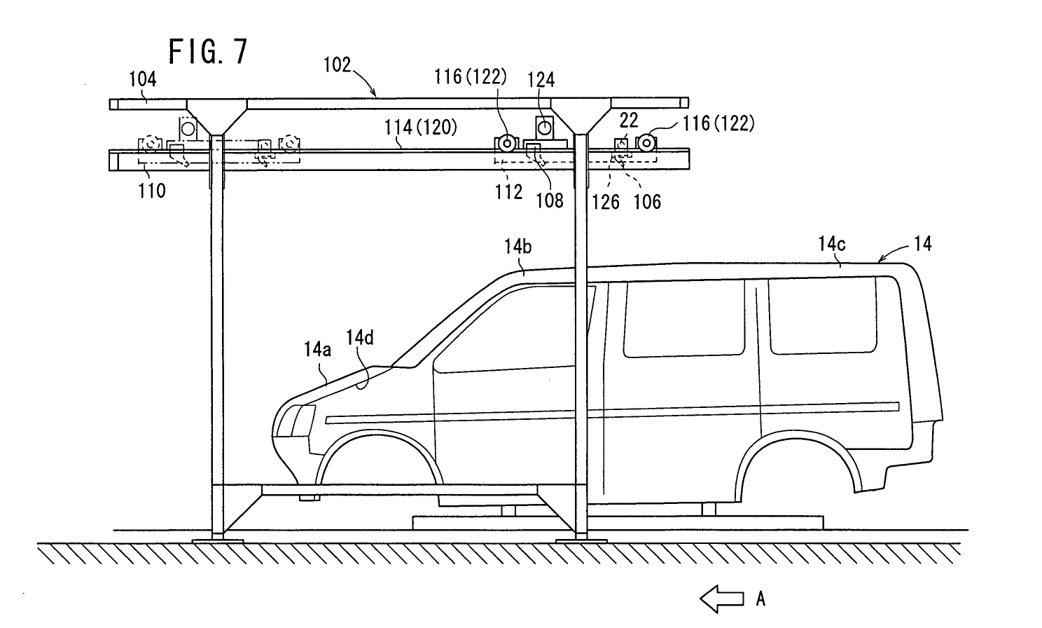

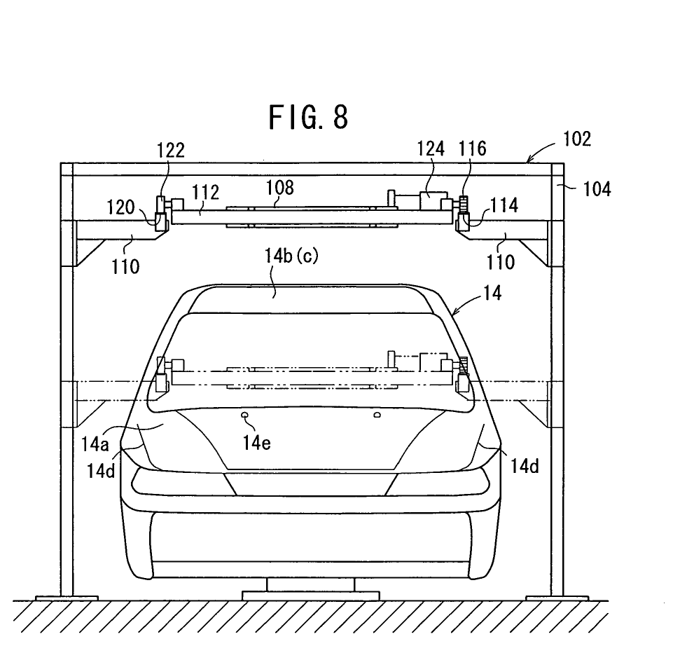

As shown in FIGS. 7 and 8, the protective precoating apparatus 102 has a portal-shaped frame structure 104 through which a vehicle 14 that is being conveyed can pass. The protective precoating apparatus 102 has a nozzle 106 for dropping a protective layer forming material onto the surface of the vehicle 14 and an air ejector 108 for applying air to the protective layer forming material dropped from the nozzle 106 to spread (blow out) the protective layer forming material over the surface of the vehicle 14.

A vertically movable frame structure 110, which is vertically movable by a drive means and a guide means, not shown, engages the frame structure 104. The vertically movable frame structure 110 is engaged by a longitudinally movable frame structure 112 which is movable in the conveying direction and has the nozzle 106 and the air ejector 108. The longitudinally movable frame structure 112 has pinions 116 held in mesh with a rack 114 and rollers 122 engaging a rail 120, and is movable back and forth on the vertically movable frame structure 110 when a motor 124 is energized.

The nozzle 106 is fixed to a nozzle base 126 that is movable in a direction perpendicular to the conveying direction, and is connected to the coating material pipe 22 that is supplied with the protective layer forming material. The nozzle base 126 is self-propelled at a desired speed on the longitudinally movable frame structure 112 by a drive means, not shown, having a servomotor, a speed reducer, etc.

The air ejector 108 is fixed to the longitudinally movable frame structure 112 downstream of the nozzle 106 with respect to the conveying direction. The air ejector 108 is connected to the compressor 152 and the air tank 154 via a solenoid-operated valve, not shown.

In the first coating station ST1 incorporating the protective precoating apparatus 102 having such a structure, vertical movement of the vertically movable frame structure 110 with respect to the frame structure 104 and back-and-forth movement of the longitudinally movable frame structure 112 along the conveying direction are controlled to adjust the range in which the protective layer forming material is dropped from the nozzle 106 and the range in which the dropped protective layer forming material is spread by the air ejector 108. In this manner, the surface of the vehicle 14 is supplied and roughly coated with the protective layer forming material.

In this case, the central roof area 14b and the rear roof area 14c of the vehicle 14 may be roughly coated. As these areas include many flat surfaces, the range in which the protective layer forming material is spread by the air ejector 108 can be adjusted relatively easily.

With the coating system 10b for a protective layer forming material according to the second embodiment, as described above, when the protective layer forming material is roughly applied in the first coating station ST1, the conventional protective precoating apparatus 102 is applied to the central roof area 14b and the rear roof area 14c which can be coated relatively easily on the surface of the vehicle 14. Since the first coating station ST1 does not require relatively expensive robots 16, the coating system lob for a protective layer forming material can be manufactured less costly.

A coating system 10c for a protective layer forming material according to a third embodiment will be described below.

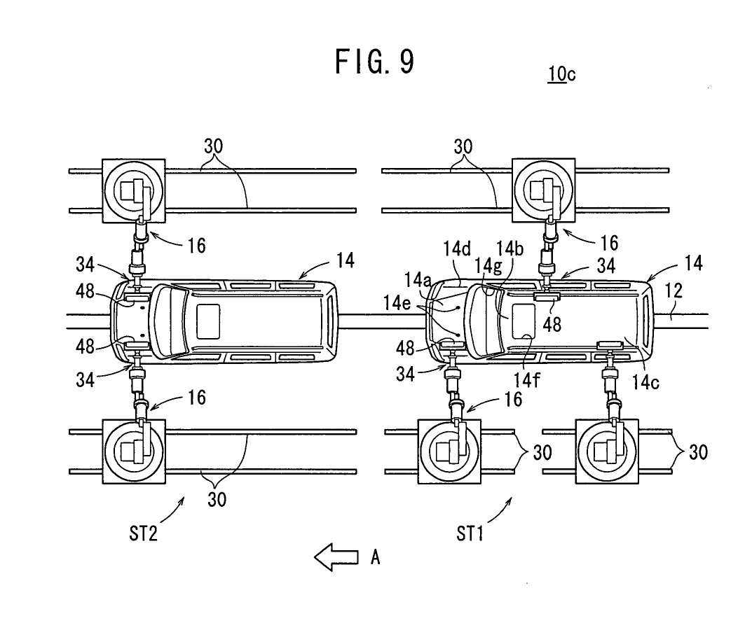

As shown in FIG. 9, the coating system 10c comprises a first coating station ST1 disposed upstream with respect to the conveying direction of vehicles 14 and a second coating station ST2 disposed downstream with respect to the conveying direction of vehicles 14.

The first coating station ST1 of the coating system 10c has two robots 16 disposed on the left side of the conveying line 12 with respect to the conveying direction of vehicles 14, and a robot 16 disposed on the right side of the conveying direction, as with the second coating station ST2 of the coating system 10a.

The second coating station ST2 of the coating system 10c has robots 16 disposed one on each side of the conveying direction of vehicles 14, as with the third coating station ST3 of the coating system 10a.

In the coating system 10c, the robots 16 of the second coating station ST2 may selectively coat areas ranging from the engine hood 14a to the front fenders 14d. Because the areas ranging from the engine hood 14a to the front fenders 14d include many curved surfaces of the vehicle 14 and are often inclined forwardly of the vehicle 14, they should be coated carefully.

A plurality of robots 16 may be disposed in each of the first and second coating stations ST1, ST2. Specifically, one or more robots 16 may be disposed on each side of the conveying line 12 in each of the first and second coating stations ST1, ST2. With the plural robots 16 disposed in each of the first and second coating stations ST1, ST2, the coating process can be completed in the two coating stations ST1, ST2. Inasmuch as one vehicle 14 is simultaneously coated by the plural robots 16, the coating process can be completed within a prescribed takt time.

With the coating system 10c according to the third embodiment, since the robots 16 for coating the vehicle 14 are appropriately positioned in the first and second coating stations ST1, ST2, the robots 16 can appropriately be assigned to processes of supplying and applying the protective layer forming material in the first and second coating stations ST1, ST2. As a result, the surface of the vehicle 14 can properly and uniformly be coated with the protective layer forming material.

Even if the protective layer forming material that has been supplied in the first coating station ST1 is not sufficient, the shortage can be compensated for by newly supplying and coating the surface of the vehicle 14 with the protective layer forming material in the second coating station ST2. As a consequence, the surface of the vehicle 14 can be coated with the protective layer forming material more properly and more uniformly. Since the coating system is flexibly compatible with the types, shapes, and numbers of produced vehicles 14, the vehicles 14 can efficiently be produced.

When the coating process is performed in the two coating stations ST1, ST2 of the coating system 10c, three robots 16 provided in the first coating station ST1 and two robots 16 provided in the second coating station ST2 can properly be assigned to their jobs (see FIG. 9). As the robots 16 are properly assigned to their jobs, the possibility of mutual interference thereof is small, and the robots 16 can easily be trained and controlled.

In the coating station ST1 of the coating system 10c, the robots 16 may be replaced with the protective precoating apparatus 102 shown in FIGS. 6 and 7.

A coating system 10d for a protective layer forming material according to a fourth embodiment will be described below.

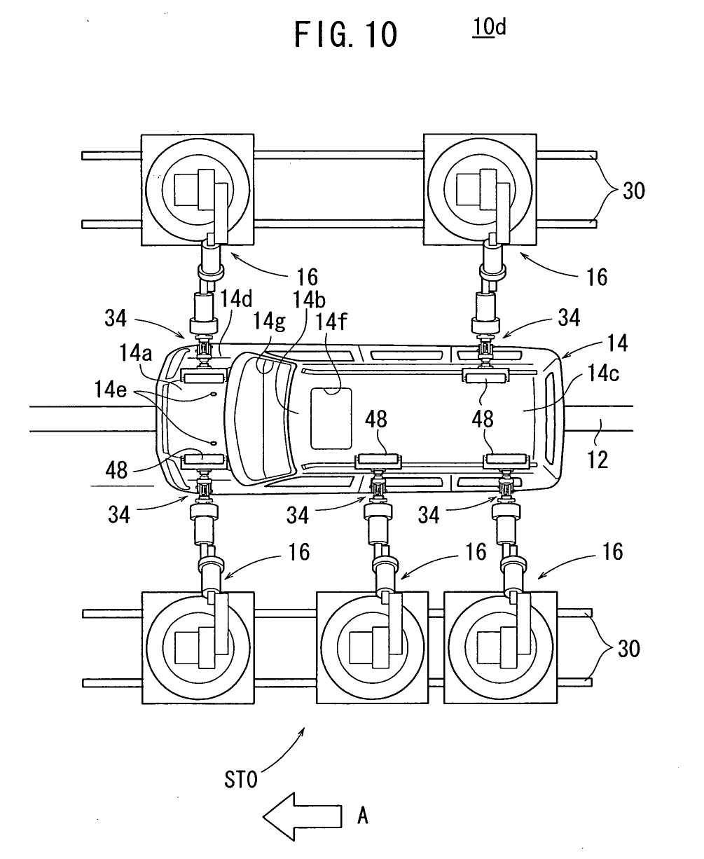

As shown in FIG. 10, the coating system 10d comprises a single coating station ST0. The coating station ST0 has three robots 16 disposed on the left side of the conveying direction of vehicles 14 and two robots 16 disposed on the right side of the conveying direction of vehicles 14. Each of the robots 16 is disposed on slide rails 30.

First, jobs to which the robots 16 of the coating station ST0 are to be assigned are determined in advance, and then the robots 16 are trained to perform coating operation. For example, the first and second robots 16 are assigned to respective left and right areas of the engine hood 14a including the front fenders 14d. The third robot 16 is assigned to the central roof area 14b. The fourth and fifth robots 16 are assigned to respective left and right areas of the rear roof area 14c.

Based on the teaching data by which the robots 16 have been trained, the control console 18 controls the coating operation of the robots 16 in the coating station ST0, thereby coating the vehicles 14 introduced into the coating system 10d with the protective layer forming material.

As shown in FIG. 10, in the coating station ST0, each of the robots 16 operates to supply and coat a surface of the vehicle 14, mainly an entire upper surface thereof, with the protective layer forming material. Specifically, each of the robots 16 roughly applies, spreads, and finishes the protective layer forming material on the area to which it is assigned, within a prescribed takt time. At this time, the protective layer forming material may be supplied only when the protective layer forming material is roughly applied, and the trigger valve 164 may be closed to stop supplying the protective layer forming material when it is spread and finished.

The areas to which adjacent ones of the robots 16 are assigned may overlap each other, and the overlapping zones may be coated separately by the robots 16 which perform roughly coating operation and the robots 16 which perform spreading and finishing operation.

Since the three robots 16 and the two robots 16 are disposed respectively on the left and right sides of the conveying line 12 in the coating station ST0, the area to which each robot 16 is assigned is small, and the coating process can be finished in one coating station ST0 only. Furthermore, because one vehicle 14 is simultaneously coated by the plural robots 16, the coating process can be completed within a prescribed takt time.

In order to complete the coating process in one coating station ST0, two or more robots 16 may be disposed on each of the left and right sides of the conveying line 12. Up to five robots 16 may be disposed in the coating station ST0 in order to easily prevent mutual interference of the robots 16 and due to size limitations of the robots 16. Consequently, the coating station ST0 should preferably have four or five robots 16.

A coating system 10e for a protective layer forming material according to a fifth embodiment will be described below.

As shown in FIG. 11, the coating system 10e for a protective layer forming material is disposed on the conveying line 12 for vehicles. In both a first coating station ST1 and a second coating station ST2, the coating system 10a coats vehicles 14 that have been painted.

The second coating station ST2 has four robots 16 which are identical to the robots 16 in the coating system 10a for a protective layer forming material. Each of the robots 16 has a roller mechanism 34 disposed on the tip end of the third arm 46.

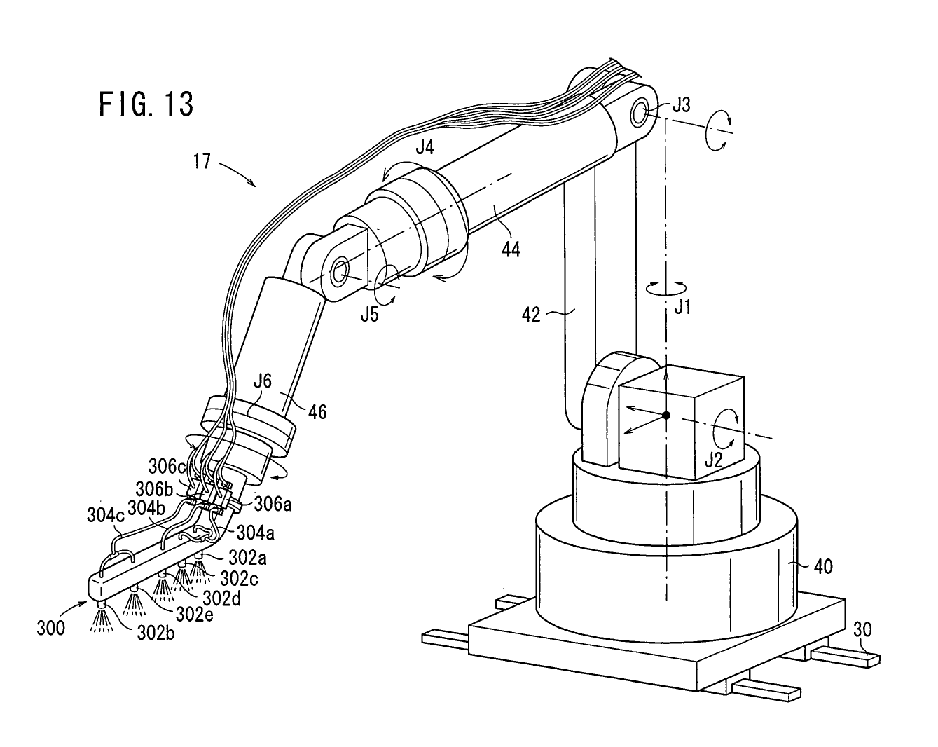

As shown in FIG. 13, the first coating station ST1 has four industrial articulated robots 17 which are structurally identical to the robots 16. Each of the robots 17 has an ejecting mechanism (applicator) 300 disposed on the tip end of the third arm 46 and supplied with the protective layer forming material through the coating material pipe 22.

The ejecting mechanism 300 has an ejector comprising a first terminal gun tip 302a closest to the third arm 46, a second terminal gun tip 302b remotest from the third arm 46, and first through third intermediate gun tips 302c through 302e interposed between the first terminal gun tip 302a and the second terminal gun tip 302b. The distance between adjacent ones of the gun tips is progressively greater from the first terminal gun tip 302a toward the second terminal gun tip 302b.

The coating material pipe 22 is divided into first through third branch pipes 304a through 304c, and the first branch pipe 304a is further divided into two branch pipes that communicate with passages (not shown) in the first terminal gun tip 302a and the first intermediate gun tip 302c. The second branch pipe 304b communicates with a passage in the second intermediate gun tip 302d. As with the first branch pipe 304a, the third branch pipe 304c is further divided into two branch pipes that communicate with passages in the third intermediate gun tip 302e and the second terminal gun tip 302b.

Supply mechanisms for ejecting the protective layer forming material or water are connected respectively to the gun tips 302a through 302e.

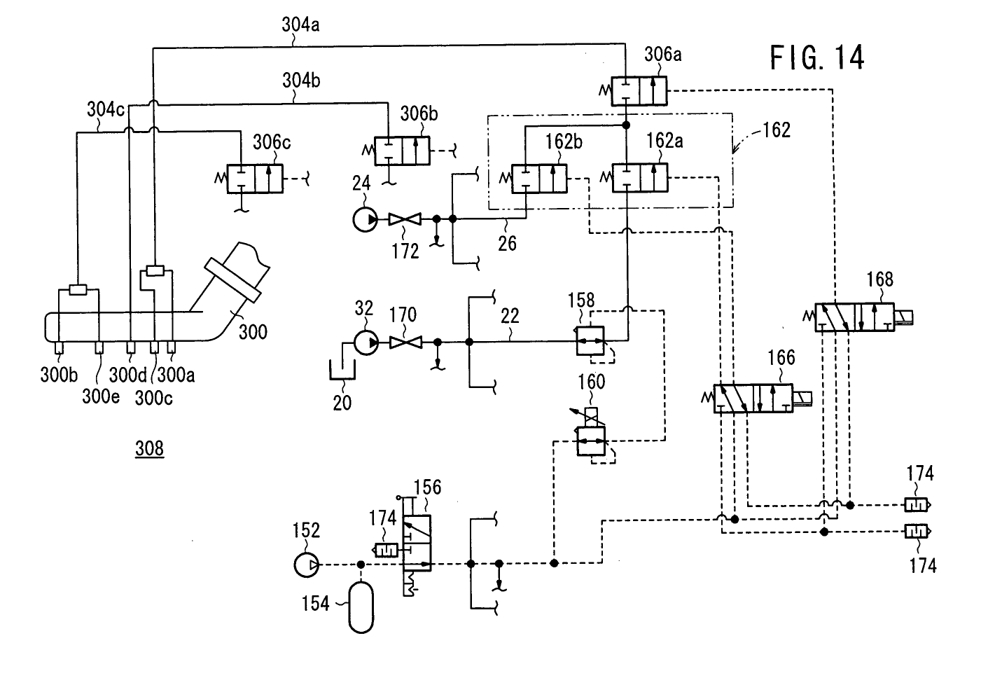

As shown in FIG. 14, the first terminal gun tip 302a and the first intermediate gun tip 302c are supplied with the protective layer forming material by a composite hydraulic and pneumatic circuit 308. The composite hydraulic and pneumatic circuit 308 is similar in structure to the composite circuit 150 (see FIG. 4), and has a trigger valve 306a, which corresponds to the trigger valve 164, connected to the first branch pipe 304a. A trigger valve 306b connected to the second branch pipe 304b and a trigger valve 306c connected to the third branch pipe 304c are connected to supply mechanisms, not shown, that are similar to the composite circuit 308.

As can be seen from FIG. 14, the gun tips 302a through 302e of the ejecting mechanism 300 are capable of ejecting the protective layer forming material free of air. The gun tips 302a through 302e thus comprise airless-type nozzles.

A process of coating a vehicle 14 with the protective layer forming material using the coating system 10e for a protective layer forming material will be described below.

In the coating system 10e, the four robots 17 in the first coating station ST1 apply the protective layer forming material to a central area of the vehicle, and the four robots 6 in the second coating station ST2 apply the protective layer forming material to end areas of the vehicle. First, the robots 17 and the robots 16 are trained for their operation.

Specifically, the robots 17 are assigned respectively to an engine hood 14a, a front roof area, a right rear roof area, and a left rear roof area of the vehicle 14, and are trained to displace the ejecting mechanisms 300 along given paths over the areas to which the robots 17 are assigned. The teaching data by which the robots 17 are trained are recorded and held in a recorder in the control console 18. The robots 17 are trained for their operation in the same manner as the robots 16 are trained. At this time, the robots 17 may be trained to hold the gun tips 302a through 302e spaced a predetermined distance from the areas to be coated as visually confirmed by the operator. Alternatively, the robots 17 may be trained by a so-called off-line teaching process.

Since the ejecting mechanism 300 is movable with six degrees of freedom by the mechanism of the robot 17 as with the roller mechanism 34, the ejecting mechanism 300 is compatible with vehicles 14 of complex shapes.

The vehicle 14 that has been painted is introduced by the conveying line 12, and stopped in the first coating station ST1.

The control console 18 recognizes that the vehicle 14 has been introduced with a signal supplied from the conveying line 12 or a sensor (not shown), and operates the robots 17 based on the teaching data. Each of the ejecting mechanisms 300 of the robots 17 is brought over a given area of the vehicle 14. The vehicle 14 and the ejecting mechanisms 300 should preferably be spaced from each other a distance in the range from about 20 mm to 70 mm.

The control console 18 controls the regulator control valve 160 through the regulator 158 (see FIG. 14) to set the pressures of the protective layer forming material flowing respectively through the first branch pipe 304a, the second branch pipe 304b, and the third branch pipe 304c, respectively, to 0.05 MPa, 0.2 MPa, and 0.5 MPa, for example, when the protective layer forming material is ejected.

The control console 18 controls the MCV 162 through the MCV switching solenoid-operated valve 166 to open the coating material pipe 22 and close the water pipe 26, and also controls the trigger switching solenoid-operated valve 168 to open the trigger valves 306a through 306c.

Under the above control of the control console 18, the protective layer forming material as it is kept at appropriate temperature is now ejected from the first terminal gun tip 302a, the first through third intermediate gun tips 302c through 302e, and the second terminal gun tip 302b to the vehicle 14. Stated otherwise, the vehicle 14 starts being coated with the protective layer forming material. At this time, as described above, the protective layer forming material is ejected under the pressure of 0.05 MPa from the first terminal gun tip 302a and the first intermediate gun tip 302c that are connected to the first branch pipe 304a, under the pressure of 0.2 MPa from the second intermediate gun tip 302d, and under the pressure of 0.5 MPa from the third intermediate gun tip 302e and the second terminal gun tip 302b.

Since the protective layer forming material is ejected under the different pressures, the spread width of the protective layer forming material is smaller at the ends of the vehicle 14 and greater at the center of the vehicle 14. Because the protective layer forming material is applied to narrower ranges at the ends of the vehicle 14, the protective layer forming material is prevented from being scattered and applied as dots.

Even if the protective layer forming material ejected from the second terminal gun tip 302b is scattered into the area which is coated with the protective layer forming material by the third intermediate gun tip 302e and applied as dots to the vehicle 14, this area is coated with the protective layer forming material ejected from the third intermediate gun tip 302e. Consequently, a uniform peelable protective layer is finally formed in this area.

According to the present embodiment, therefore, the protective layer forming material is prevented from being scattered around at the ends of the vehicle 14. Even if the protective layer forming material is scattered into the central area, since the central area is coated differently with the protective layer forming material, coating irregularities are prevented from occurring.

Since the protective layer forming material is ejected from the gun tips 302a through 302e, the protective layer forming material can be applied to a wide range within a short period of time.

While the above coating process is being performed, the robots 17 are displaced at a predetermined speed on the slide rails 30. After the protective layer forming material has been applied, the vehicle 14 is delivered along the conveying line 12 into the second coating station ST2. The robots 17 are then retracted to a position out of interference to the vehicle 14, and wait in that position until a next vehicle 14 is introduced. At this time, the control console 18 closes the trigger valves 306a through 306c to stop supplying the protective layer forming material.

In the second coating station ST2, the vehicle 14 which has been coated in its central area with the protective layer forming material in the first coating station ST1 is coated in its ends with the protective layer forming material.

The control console 18 controls the regulator 158 of the composite circuit 150 (see FIG. 4) to control the pressure in the coating material pipe 22 at an appropriate level. The control console 18 also controls the MCV 162 through the MCV switching solenoid-operated valve 166 as described above.

The ends of the vehicle 14 are now coated with the protective layer forming material. The thickness of the protective layer forming material applied to the vehicle 14 can be adjusted by the pressure controlled by the regulator 158 and the speed of operation of the robots 16.

With the coating system 10e, as described above, the central area of the vehicle 14 is coated with the protective layer forming material by the ejecting mechanisms 300 which have excellent coating efficiency, and the other areas than the central area, i.e., the ends that require a relatively high coating accuracy, are coated with the protective layer forming material by the roller mechanisms 34. Therefore, coating failures and coating irregularities are avoided. The area coated by the ejecting mechanisms 300 and the area coated by the roller mechanisms 34 may overlap each other.

When the coating system 10e is to be shut off or the ejecting mechanisms 300 are serviced for maintenance, the MCV 162 is operated through the MCV switching solenoid-operated valve 166 in the composite circuit 308 to close the switching valve 162a and open the switching valve 162b. Water is now supplied from the water pipe 26 to clean the MCV 162, the trigger valves 306a through 306c, and the gun tips 302a through 302e.

When the roller mechanisms 34 are serviced for maintenance, the composite circuit 150 may be operated in the same manner as described above. Water is supplied from the water pipe 26 to clean the MCV 162, and the trigger valve 164 in the composite circuit 150, and the rollers 48.

The coating system 10e applies the protective layer forming material through the ejecting mechanisms 300 in the first coating station ST1, and applies the protective layer forming material through the roller mechanisms 34 in the second coating station ST2. However, the coating system 10e may apply the protective layer forming material through the roller mechanisms 34 in the first coating station ST1, and apply the protective layer forming material through the ejecting mechanisms 300 in the second coating station ST2.

The distances between adjacent ones of the gun tips may be set to the same value, and the protective layer forming material may be ejected under the same pressure.

The robots 17 in the first coating station ST1 may roughly apply the protective layer forming material, and the robots 16 in the second coating station ST2 may spread and finish the roughly applied protective layer forming material. In this case, the rollers 48 of the robots 16 may not supply the protective layer forming material.

With the coating systems 10a through 10e for a protective layer forming material according to the above embodiments, since the process of applying the protective layer forming material is automated, the worker is not required to manually finish the coating and hence the coating quality is uniformized. As the worker does not need to apply the protective layer forming material because of the automated process, the number of process steps is reduced for increased production efficiency, and an air-conditioning system for the worker is dispensed with. Because no electric energy is required for such an air-conditioning system, the coating systems are an energy saver, are more environment-friendly, and reduce the operating cost of the factory.

Areas of complex shapes or small areas of the vehicle 14 which cannot automatically be processed by the robots 16 or the robots 17 may be finished by the worker. Since the vehicle 14 has less coating failures where the vehicle fails to be coated with the protective layer forming material, the burden on the worker is greatly reduced.

The peelable protective layer that is formed from the protective layer forming material is effective to protect the painted area of the vehicle 14 after the vehicle 14 is shipped, and can be used as a substitute for a scratch cover because the peelable protective layer protects the painted area in the factory. Therefore, many scratch covers having different shapes for different vehicle types can be dispensed with.

1. A coating system for a protective layer forming material, comprising:
a robot disposed closely to a conveying line for a vehicle and having an applicator on a tip end thereof, said robot being trainable for operation;
two or three coating stations disposed along said conveying line, each of said coating stations having a predetermined number of said robots; and
a supply mechanism for supplying said applicator with a liquid-phase protective layer forming material which will form a peelable protective film after being dried;
wherein said coating stations include a first coating station for supplying said protective layer forming material to a surface of said vehicle through said applicators of said robots, and roughly applying said supplied protective layer forming material.

2. A coating system according to claim 1, wherein said protective layer forming material comprises an acrylic copolymer.

3. A coating system according to claim 1, wherein said coating stations include second or third coating stations, and said robots in at least one of said second and third coating stations apply said protective layer forming material while newly supplying said protective layer forming material through said applicators.

4. A coating system according to claim 1, wherein said applicator comprises a roller made of a material which is capable of absorbing and holding said protective layer forming material.

5. A coating system according to claim 1, wherein said first coating station has a discharging and coating mechanism for discharging or dropping and spreading said protective layer forming material, in place of said robots.

6. A coating system according to claim 1, wherein said coating stations comprise:
said first coating station;
a second coating station for spreading said protective layer forming material which has roughly been applied by said applicators and supplying said protective layer forming material; and
a third coating station for finishing said protective layer forming material which has been spread by said applicators and supplying said protective layer forming material.

7. A coating system according to claim 6, wherein said first coating station has two of said robots;
said second coating station has three of said robots; and
said third coating station has two of said robots.

8. A coating system according to claim 1, wherein said coating stations comprise:
said first coating station; and
a second coating station for spreading said protective layer forming material which has roughly been applied by said applicators and supplying said protective layer forming material.

9. A coating system according to claim 8, wherein said first coating station has three of said robots; and
said second coating station has two of said robots.

10. A coating system according to claim 1, further comprising:
ejecting mechanisms disposed in said first coating station for ejecting said protective layer forming material from ejectors of said robots and applying said ejected protective layer forming material to said vehicle; and
roller mechanisms disposed in at least one of second and third coating stations of said coating stations, for supplying said protective layer forming material to rollers of said robots and rotating said rollers on said vehicle to apply said protective layer forming material to said vehicle.

11. A coating system for a protective layer forming material, comprising:
a robot disposed closely to a conveying line for a vehicle and having an applicator on a tip end thereof, said robot being trainable for operation;
a coating station disposed along said conveying line and having at least two of said robots on each of left and right sides of said conveying line; and
a supply mechanism for supplying said applicator with a liquid-phase protective layer forming material which will form a peelable protective film after being dried;
wherein said coating station supplies said protective layer forming material to a surface of said vehicle through said applicators of said robots, and roughly applies and finishes said supplied protective layer forming material.

12. A coating system according to claim 11, wherein said coating station includes five of said robots.

13. A coating system for coating a workpiece with a liquid-phase protective layer forming material which will form a peelable protective film after being dried in each of a first coating station and a second coating station, comprising:
ejecting mechanisms disposed in either one of said first coating station and said second coating station, for ejecting said protective layer forming material from ejectors of coating apparatus and applying said ejected protective layer forming material to an area of said workpiece; and
roller mechanisms disposed in the other of said first coating station and said second coating station, for supplying said protective layer forming material to rollers of said coating apparatus and rotating said rollers on said workpiece to apply said protective layer forming material to an area of said workpiece other than said area thereof which has been coated by said ejecting mechanisms.

14. A coating system according to claim 13, wherein said coating apparatus comprise robots, and said workpiece comprises a vehicle.

15. A coating system according to claim 14, wherein said roller mechanisms coat ends of said vehicle with said protective layer forming material.

16. A coating system according to claim 13, wherein said ejecting mechanisms apply said protective layer forming material in said first coating station, and said roller mechanisms apply said protective layer forming material in said second coating station.

17. A coating system according to claim 13, wherein said ejecting mechanisms are disposed in said first coating station, and said roller mechanisms are disposed in said second coating station.

18. A coating system according to claim 13, wherein said ejectors are capable of ejecting said protective layer forming material free of air.

19. A coating system according to claim 13, further comprising a water pipe for supplying water to said ejectors, wherein said ejectors are cleaned by water supplied thereto.

20. A coating system according to claim 13, wherein said rollers are made of a material which is capable of absorbing and holding said protective layer forming material.
